(19) United States
(12) Patent Application Publication
(10) Pub. No.: US 2005/0130704 A1
(43) Pub. Date: Jun. 16, 2005

(54) Credit limit recommendation

(75) Inventors: Patricia Alice McParland, Morristown, NJ (US); Keith Edward Gastauer, Hoboken, NJ (US); James Evans Parry, Easton, PA (US); Brenda Ann Karahalios, Asbury, NJ (US); Jeffery F. Brill, Schnecksville, PA (US); Alpa Madhukar Sheth, Brooklyn, NY (US)

Correspondence Address: Paul D. Greeley, Esq.;Ohlandt, Greeley, Ruggiero & Perle, L.L.P., 10th Floor, One Landmark Square, Stamford, CT, 06901-2682, US

(73) Assignee: Dun & Bradstreet, Inc.

(21) Appl. No.: 10/736,126

(22) Filed: Dec. 15, 2003

(51) Int. Cl. H04Q 7/20

(52) U.S. Cl. 455/556.2

(57) ABSTRACT

A credit limit recommendation helps customers more easily manage credit decisions. The credit limit recommendation has two guidelines: an aggressive limit and a conservative limit. The recommendation may be a specific dollar amount or a range or other information. The guidelines are based on an historical analysis of credit demand of customers in a business information database having a similar profile to the business being evaluated with respect to employee size and industry. The feature is available as a clickable link and each recommendation may be billed separately or as part of a subscription service.

### BACKGROUND OF THE INVENTION

1. Field of the Invention

The present disclosure generally relates to credit management. In particular, the present disclosure relates to providing a credit limit recommendation, aggressive models, conservative models, finance, banking, and other applications and features.

2. Discussion of the Background Art

Credit managers do not always have the resources, time, and skills to interpret large amounts of data, such as UCC filings, balance sheets, historical payment data, and other financial information in order to determine a credit limit. In addition, some conventional financial information sources are costly, inefficient, and often provide more information than is needed to make a simple credit decision. More and more, customers lack the knowledge and tools to establish credit lines. There is a need for a cost-efficient way to manage credit decisions.

### SUMMARY OF THE INVENTION

The present invention has many aspects and is directed to a credit limit recommendation that fulfills the above needs and more.

One aspect is a method of providing a credit limit. A request for a credit limit for an entity is received. An aggressive value is retrieved from an aggressive model of business data associated with the entity. A conservative value is retrieved from a conservative model of business data associated with the entity. A recommendation based on the aggressive value and the conservative value is provided. In some embodiments, the recommendation is provided to a user from a website via a browser. In some embodiments, a user is prompted for the request from a business report associated with the entity via a clickable link. In some embodiments, the recommendation includes guidelines having an aggressive limit and a conservative limit. In some embodiments, the recommendation is a specific dollar amount. In some embodiments, the recommendation is a range, such as a five point scale. In some embodiments, the aggressive and conservative models include analysis of a payment history associated with the entity. In some embodiments, the models perform an historical analysis of credit demand of entities in a business information database having a profile similar to the entity. The similarity includes employee size and industry. In some embodiments, the recommendation is fine-tuned to account for a stability of selected large and established entities having a slow payment history. In some embodiments, there is a computer readable medium having executable instructions stored thereon to perform this method.

Another aspect is a system for providing a credit limit, which comprises a display, an aggressive model, a conservative model, and a credit limit recommendation component. The display has a clickable link to a credit limit recommendation for an entity. The aggressive model provides an aggressive value. The conservative model provides a conservative value. The credit limit recommendation component provides a recommendation based on the aggressive value and the conservative value. In some embodiments, the system also includes a database. The database is indexable by a unique business identifier identifying the entity. The database provides the business data to the aggressive and the conservative models. In some embodiments, the recommendation includes a risk category. In some embodiments, the recommendation includes an explanation, if the risk category is high. In some embodiments, the recommendation includes a range from the aggressive value to the conservative value. In some embodiments, the recommendation includes a specific dollar amount. In some embodiments, the system also includes a billing component. The billing component receives billing information, before the recommendation is provided. In some embodiments, the billing component charges a fee for the recommendation. In some embodiments, the system provides the recommendation for a subscriber service.

### BRIEF DESCRIPTION OF THE DRAWINGS

These and other features, aspects, and advantages of the present disclosure will become better understood with reference to the following description, appended claims, and drawings where:

FIG. 1 is a screenshot of an example user interface for processing a credit limit recommendation;

FIG. 2 is a screenshot of an example user interface for providing a credit limit recommendation;

FIG. 3 is a screenshot of another example user interface for providing a credit limit recommendation;

FIG. 4 is a screenshot of an example user interface, which provides for a prompt for requesting a credit limit recommendation;

FIG. 5 is a screenshot of an example user interface, which provides for another prompt for requesting a credit limit recommendation;

FIG. 6 is a screenshot of an example user interface for receiving input for a credit limit recommendation;

FIG. 7 is a screenshot of an example user interface for providing a credit limit recommendation;

FIG. 8 is a flow chart of an example website for providing a credit limit recommendation; and

FIG. 9 is a flow chart of another example website for providing a credit limit recommendation.

### DETAILED DESCRIPTION OF THE PREFERRED EMBODIMENT

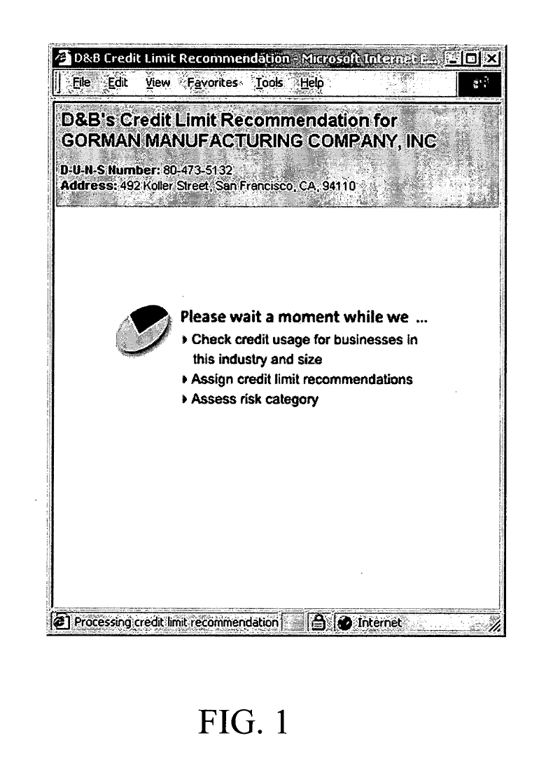

FIG. 1 shows an example user interface for processing a credit limit recommendation. In this example, a credit limit recommendation feature is available from a website or as a button, a clickable link, or the like. Given the entity Gorman Manufacturing Co., software components check the credit usage of businesses with similar size and industry as Gorman, assign a credit limit recommendation, and assess the risk category. Credit usage is historical data of loans and payments and other business and financial information. A credit limit recommendation is a recommendation based on analysis of business and financial information to help a credit manager make a credit decision. A risk category is an indication of a level of risk associated with extending credit, such as a red, yellow, or green light icon, a high, medium, or low identifier, or other indications or information. This example user interface is displayed when the request for a credit limit is being processed, which is typically a very short wait.

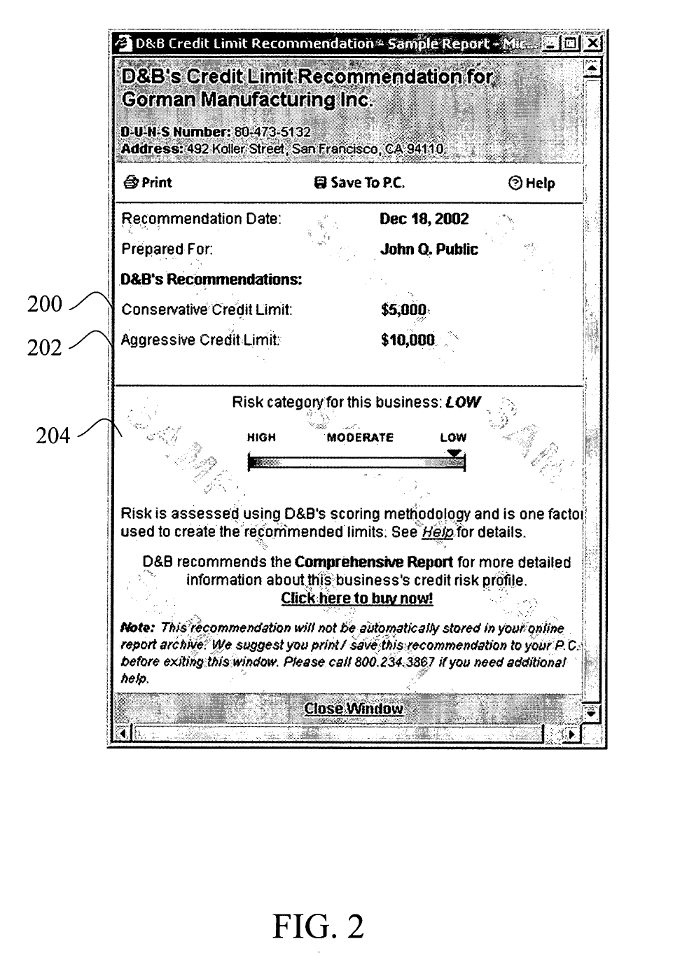

FIG. 2 shows an example user interface for providing a credit limit recommendation. In this example, the recommendation includes a conservative credit limit value 200, an aggressive credit limit value 202, and a risk category 204.

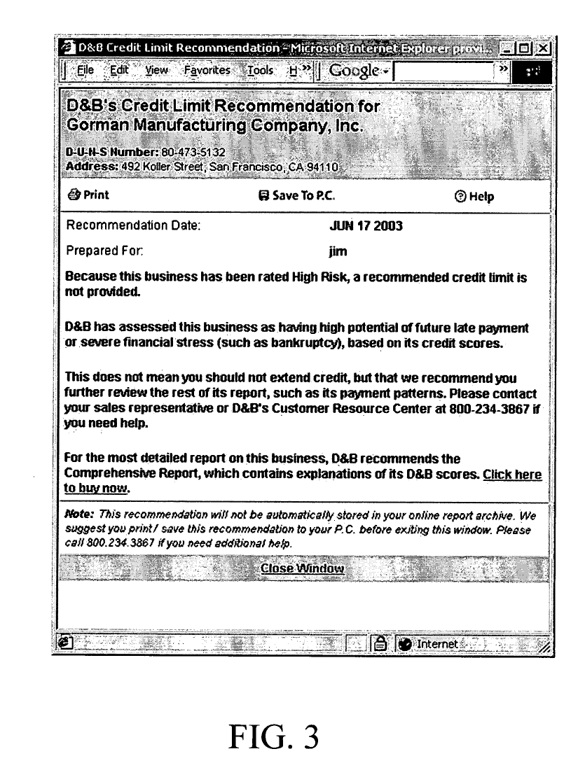

FIG. 3 shows another example user interface for providing a credit limit recommendation. In this example, a recommendation is not provided for a high risk category. In some embodiments, recommendations are provided even when the risk category is a high one. In addition, an explanation and other information is provided.

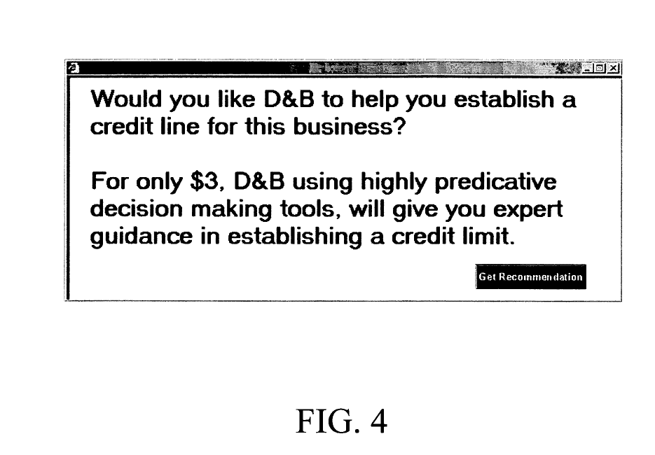

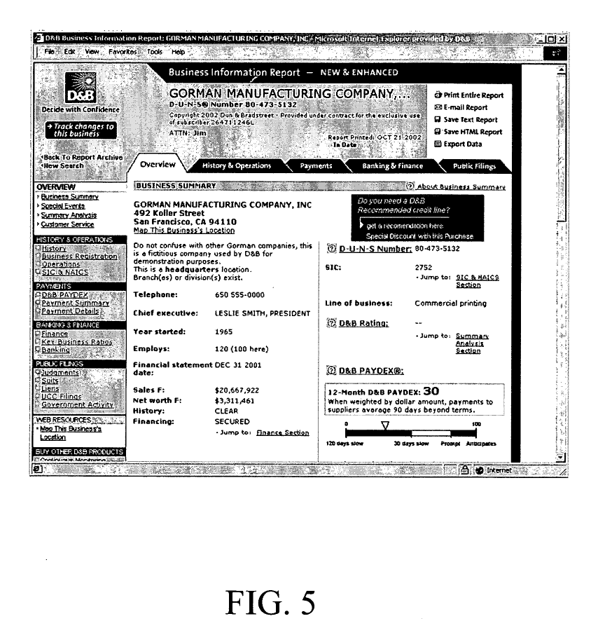

FIGS. 4 and 5 show example user interfaces for a prompt, which provides for requesting a credit limit recommendation. FIG. 4 shows a pop-up box and a button. FIG. 5 shows a context-sensitive ad, however, this feature is not limited to any design and the user may be prompted in any manner. A prompt may be given from a business report, such as the Business Information Report (BIR) or the Comprehensive Report, available from Dun & Bradstreet.

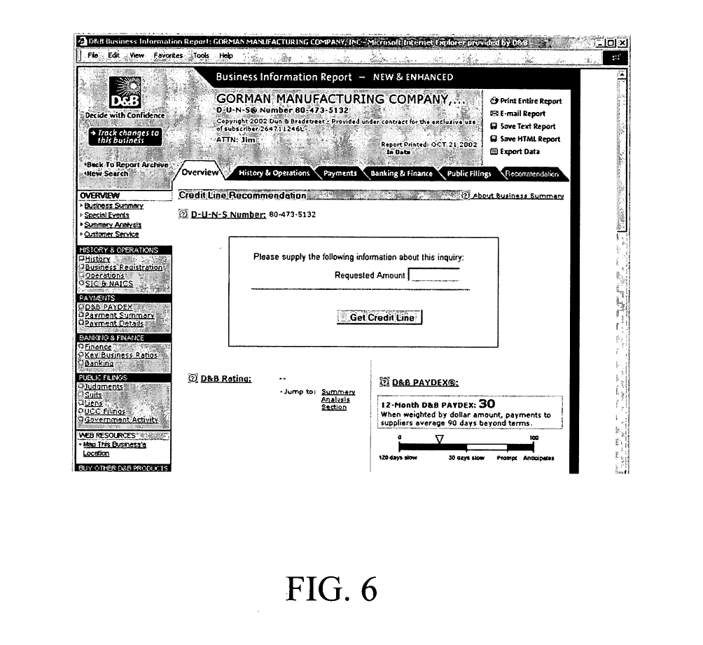

FIG. 6 shows an example user interface for receiving input for a credit limit recommendation. In this example, a requested amount is entered by a user. This feature is optional. If entered, the requested amount is compared to the recommendation and used in the risk category.

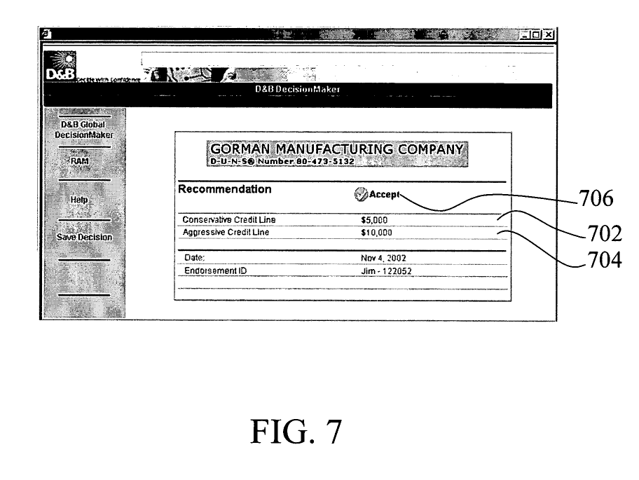

FIG. 7 shows an example user interface for providing a credit limit recommendation. In this example, a conservative credit limit value 700, an aggressive credit limit value 702 and a risk category 704 is provided. In this example, the user had entered a requested amount so risk category 704 indicates that the requested amount is less than the conservative credit limit value. If the requested amount is less than the aggressive credit limit value and greater than the conservative credit limit value, then a yellow accept with a caution symbol is displayed. If the requested amount is greater than the aggressive credit limit value, then a red reject symbol is displayed. The recommendation is provided based on analysis performed by various statistical models with access to business and financial data as well as fine-tuning. For example, models from the Global Decision Maker™ available from Dun & Bradstreet may be used. In addition, rules may be included in the software components processing the recommendation to take various factors into account, such as the stability of large, established companies who may pay slowly. In some embodiments, the recommendation is provided to small businesses, includes links to an credit insurance site, and has European options.

In this example, the conservative limit value suggests a dollar benchmark if the user's policy is to extend less credit to minimize risk. The aggressive limit value suggests a dollar benchmark if the user's policy is to extend more credit with potentially more risk. The dollar guideline amounts are based on a historical analysis of credit demand of customer demand of customers in a payments database that have a similar profile to the entity being evaluated with respect to information such as employee size and industry. The guidelines are benchmarks; they do not address whether a particular entity is able to pay that amount or whether a particular customer's total credit limit has been achieved (based on their total trade experiences and outstanding balances). They are a useful starting point, not to replace a credit manager's own analysis.

In this example, the risk category is an assessment of how likely the entity is to continue to pay its obligations within the terms and its likelihood of undergoing financial stress in the near future, such as the next year. A risk category is created using a modeling methodology and based on the entity's credit and financial stress scores.

In this example, recommendations are based on standard credit rules developed using a modeling methodology for custom credit limit analysis for customers across a wide range of industries. To develop a recommendation in this example, a subset of several million entities from a database of payment information is selected. These include single locations and headquarters and entities with actual payment experiences and enough information to generate a credit score. Then, this information is segmented by industry group and employee size to determine a spectrum of credit usage in a particular segment. Finally, the risk of potential late payment and financial stress is assessed for these entities. The industry, employee size, and risk is considered in the recommendation and the assessment of overall risk, such as high, moderately high, moderate, moderately, low, or low.

In this example, two pieces of information are used to create a risk category, a commercial credit score and a financial stress score. The commercial credit score predicts the likelihood that an entity will pay its bills in a severely delinquent manner, e.g. +90 days past term, over the next 12 months. The commercial credit score uses statistical probabilities to classify risk based on a full spectrum of business information, including payment trends, company financials, industry position, company size and age, and public filings. The financial stress score predicts an entity's potential for failure. It predicts the likelihood that an entity will obtain legal relief from creditors or cease operations without paying all creditors in full over the next 12 months. The financial stress score uses a full range of information, including financial rations, payment trends, public filings, demographic data, and more.

In this example, high risk indicates an entity that has a high projected rate of delinquency (from a credit score) or a high failure risk (from a stress score). Moderate risk indicates a moderate projected risk of delinquency (from the stress score) and a moderate to low risk of failure (from the stress score). Entities whose credit scores fall between moderate and high appear as moderately high and entities whose credit scores fall between moderate and low appear as moderately low. Entities with financial stress (failure) scores assessed as high risk automatically receive a high risk assessment, even if their projected delinquency rate is low or moderate. Any entity that receives a risk category assessment of high does not receive a recommendation.

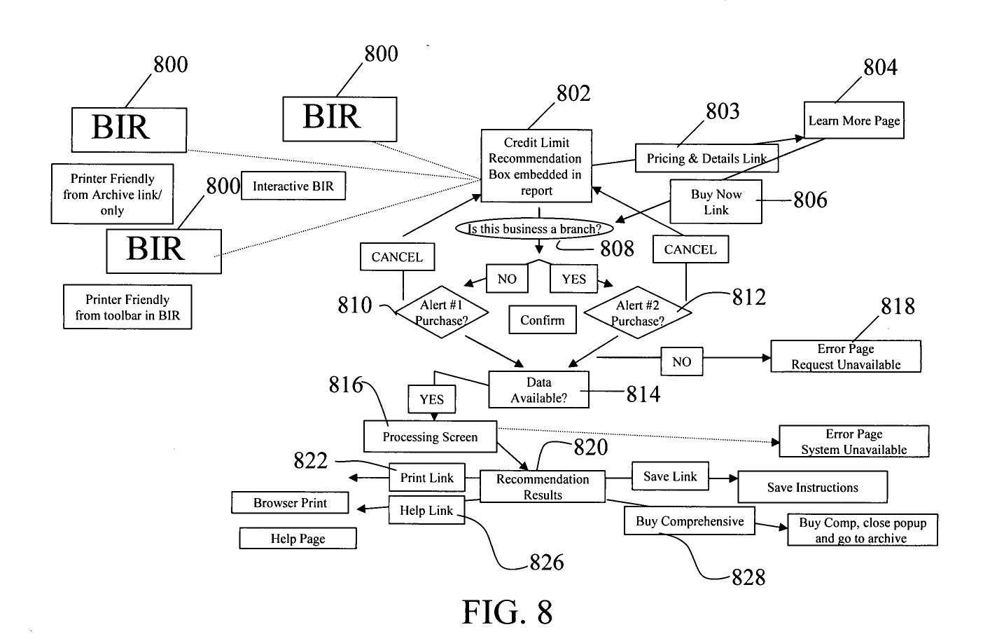

FIG. 8 shows an example website for providing a credit limit recommendation. In this example, several business reports include an embedded credit limit recommendation box 802. The business reports include a printer friendly from archive link, an interactive link, a printer friendly toolbar, and a side navigation link. From embedded credit limit recommendation box 802 there is a pricing and details link 803 going to a learn more page 804. Learn more page 804 has a buy now link 806 going to a determination of whether the selected business is a branch 808. If not, control flows to an alert #1 purchase 810; otherwise to an alert #2 purchase 812. Both alerts 810, 812 go to a determination of whether data is available 814. If so, control flows to a processing screen 816; otherwise to an error page 818. From processing screen 816, control normally flows to recommendation results 820, where print 822, save 824, or help 826 functions are available. Additionally, an option to buy a comprehensive report 828 is available.

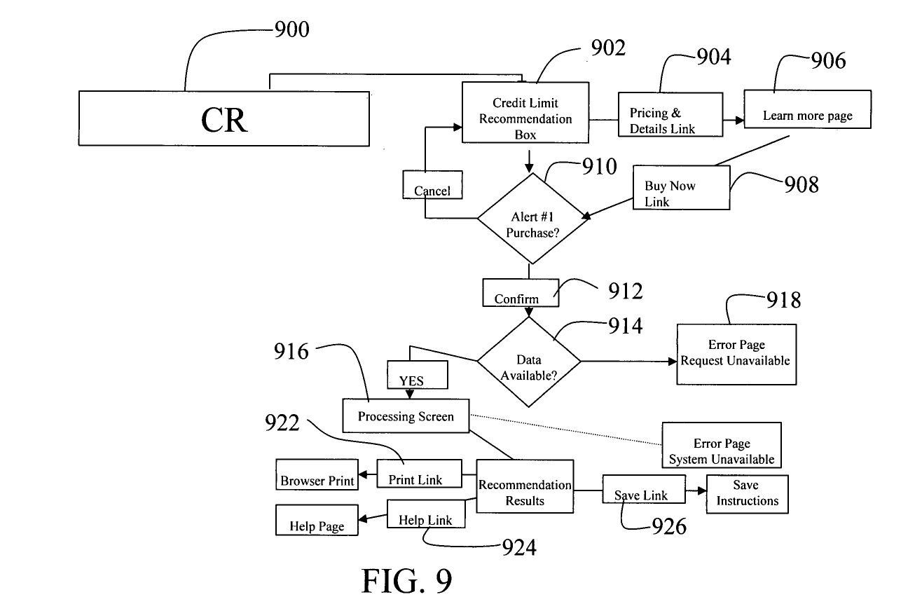

FIG. 9 shows another example website for providing a credit limit recommendation. In this example, a business report 900 includes a credit limit recommendation box 902. From credit limit recommendation box 902 there is a pricing and details link 904 to a learn more page 906. Learn more page 906 has a buy now link 908 going to an alert #1 purchase 910. Alert #1 purchase receives a confirmation 912 and determines whether data is available 914. If so, control flows to processing screen 916; otherwise an error page is displayed 918. From processing screen 916, control flows to recommendation results 920, where there are print 922, help 924, and save 926 functions available.

It is to be understood that the above description is intended to be illustrative and not restrictive. Many other embodiments will be apparent to those of skill in the art upon reviewing the above description, such as adaptations of the present disclosure to financial and business decision aids for applications other than credit limits. Various designs using hardware, software, and firmware are contemplated by the present disclosure, even though some minor elements would need to change to better support the environments common to such systems and methods. The present disclosure has applicability to fields outside credit limits, such as credit reports and other kinds of websites needing business and financial information. Therefore, the scope of the present disclosure should be determined with reference to the appended claims, along with the full scope of equivalents to which such claims are entitled.

1. A method of providing a credit limit, comprising:
receiving a request for a credit limit related to an entity;
retrieving an aggressive value from an aggressive model of business data associated with said entity;
retrieving a conservative value from a conservative model of business data associated with said entity; and
providing a recommendation based on said aggressive value and said conservative value.

2. The method according to claim 1, wherein said recommendation is provided to a user from a website via a browser.

3. The method according to claim 1, further comprising:
prompting a user for said request from a business report associated with said entity via a clickable link.

4. The method according to claim 1, wherein said recommendation includes guidelines having an aggressive limit and a conservative limit.

5. The method according to claim 1, wherein said recommendation is a specific dollar amount.

6. The method according to claim 1, wherein said recommendation is a range of dollar amounts.

7. The method according to claim 1, wherein said aggressive and conservative models include analysis of a payment history associated with said entity.

8. The method according to claim 1, wherein said aggressive and conservative models perform an historical analysis of credit demand of entities in a business information database having a profile substantially similar to said entity.

9. The method according to claim 8, wherein said profile is at least one attribute selected from the group consisting of: employee size and industry.

10. The method according to claim 1, wherein said recommendation is fine-tuned to account for known characteristics of a particular entity.

11. A computer readable medium having executable instructions stored thereon to perform a method of providing a credit limit, said method comprising:
receiving a request for a credit limit related to an entity;
retrieving an aggressive value from an aggressive model of business data associated with said entity;
retrieving a conservative value from a conservative model of business data associated with said entity; and
providing a recommendation based on said aggressive value and said conservative value

12. A system for providing a credit limit, comprising:
a display having a clickable link to a credit limit recommendation for an entity;
an aggressive model, which provides an aggressive value; a conservative model, which provides a conservative value; and
a credit limit recommendation component, which provides a recommendation based on said aggressive value and said conservative value.

13. The method according to claim 12, further comprising:
a database indexable by a unique business identifier identifying said entity, said database, which provides said business data to said aggressive and said conservative models.

14. The system according to claim 12, wherein said recommendation includes a risk category.

15. The system according to claim 12, wherein said recommendation includes an explanation, if said risk category is high.

16. The system according to claim 12, wherein said recommendation includes a range from said aggressive value to said conservative value.

17. The system according to claim 12, wherein said recommendation includes a specific dollar amount.

18. The system according to claim 12, further comprising:
a billing component to receive billing information, before said recommendation is provided.

19. The system according to claim 18, wherein said billing component charges a fee for said recommendation.

20. The system according to claim 12, wherein said system provides said recommendation for a subscriber service.
